(19) United States
(12) Patent Application Publication
(10) Pub. No.: US 2019/0324900 A1
(43) Pub. Date: Oct. 24, 2019

(54) INFORMATION PROCESSING SYSTEM, READING DEVICE, AND INFORMATION PROCESSING METHOD

(71) Applicant: PFU Limited, Ishikawa (JP)

(72) Inventor: Masahito SAKUI, Ishikawa (JP)

(73) Assignee: PFU Limited, Ishikawa (JP)

(21) Appl. No.: 16/058,791

(22) Filed: Aug. 8, 2018

(30) Foreign Application Priority Data
Apr. 19, 2018 (JP) 2018-080476

(51) Int. Cl. G06F 12/02; H04N 1/44; G06F 1/32; G06F 9/4401

(52) U.S. Cl. CPC G06F 12/0246; G06F 9/4418; G06F 1/3225; H04N 1/4426

(57) ABSTRACT

The present invention provides an information processing system configured to prevent an unauthorized duplication, reading or the like of a recording medium.

There is provided an information processing system having: a reading device configured to read data from a recording medium; and an information provision device configured to provide information used for reading data from the recording medium, wherein the reading device comprises: a memory; and a processor coupled to the memory configured to: store in the memory information provided from the information provision device; read data from the recording medium by using the information stored in the memory; and delete the information stored in the memory when a predetermined condition is satisfied.

### CROSS-REFERENCE TO RELATED APPLICATIONS

This application is based on and claims priority under 35 USC 119 from Japanese Patent Application No. 2018-080476 filed Apr. 19, 2018.

### FIELD

The present invention relates to an information processing system, a reading device, and an information processing method.

### BACKGROUND ART

For example, Japanese Patent Application Laid-Open (JP-A) No. 2008-244518 discloses an image formation device management system configured so that an image formation device 17 obtains IC card identification information by an IC card reader 174, a management server 11 obtains a user ID corresponding to the obtained IC card identification information and usage limitation information on use for the image formation device 17, and based on the usage limitation information, causes a process in the image formation device 17 to be executed.

### SUMMARY OF THE INVENTION

According to an aspect of the invention, there is provided an information processing system comprising a reading device configured to read data from a recording medium; and an information provision device configured to provide information used for reading data from the recording medium, wherein the reading device comprises a memory; and a processor coupled to the memory configured to: store in the memory information provided from the information provision device; read data from the recording medium by using the information stored in the memory; and delete the information stored in the memory when a predetermined condition is satisfied.

According to another aspect of the invention, there is provided a reading device comprising a memory; and a processor coupled to the memory configured to: store in the memory information used for reading data from a recording medium, wherein the information is provided from outside; read data from the recording medium by using the information stored in the memory; and delete the information stored in the memory when a predetermined condition is satisfied.

According to another aspect of the invention, there is provided an information processing method comprising the steps of: obtaining information used for reading data from a recording medium, from outside; storing the obtained information into a predetermined recording region; reading data from the recording medium by using the information stored in the recording region; and deleting the information stored in the recording region when a predetermined condition is satisfied.

### BRIEF DESCRIPTION OF THE DRAWINGS

Exemplary embodiments of the present invention will be described in detail based on the following figures.

FIG. 1 is a drawing illustrating an overall configuration of an information processing system 1;

FIG. 2 is a drawing illustrating a hardware configuration of a management server 2;

FIG. 3 is a diagram illustrating a hardware configuration of a control device 60 incorporated in a scanner 6A;

FIG. 4 is a drawing illustrating a functional configuration of the management server 2 and the scanner 6A;

FIG. 5 is a sequence chart explaining an overall operation (S10) of the information processing system 1; and

FIG. 6A illustrates a recording region on an NFC card 9 and FIG. 6B shows an example of parameter information used for reading the NFC card 9.

### DESCRIPTION OF EMBODIMENTS

### Background and Summary

There is a device (scanner/printer or the like) provided with a user authentication function of determining whether or not a user is an authenticated one by reading, by an NFC reader, an NFC chip (hereinafter, NFC) embedded in an employee ID card or the like.

To read data from the NFC by the NFC reader provided in the device, parameter information which is defined for each NFC and used for reading the data from the NFC is needed. To do so, typically, the parameter information used for reading the data from the NFC is previously held in the device.

However, when the parameter information resides all the time in the device, the parameter information may be leaked due to the device being stolen or the like, and as a result, there are risks of unauthorized use of the NFC card and unauthorized information extraction from the NFC card or the like.

Further, when the NFC to be utilized is changed, or when there is a change to user authentication (user name/password or the like) different from the NFC, it is needed to apply a setting change to each of all the devices, and thus, a cost related to the setting change is huge.

Therefore, in an information processing system 1 according to the present embodiment, an authentication method/parameter information are not held in a device all the time, instead, only when a need arises, the authentication method and the parameter information are distributed and the parameter information or the like in the device is deleted when there is no such need anymore. Further, in the information processing system 1, a collective setting and distribution are enabled at a server side to eliminate a burden of applying a setting change to each of all the devices.

### EMBODIMENT

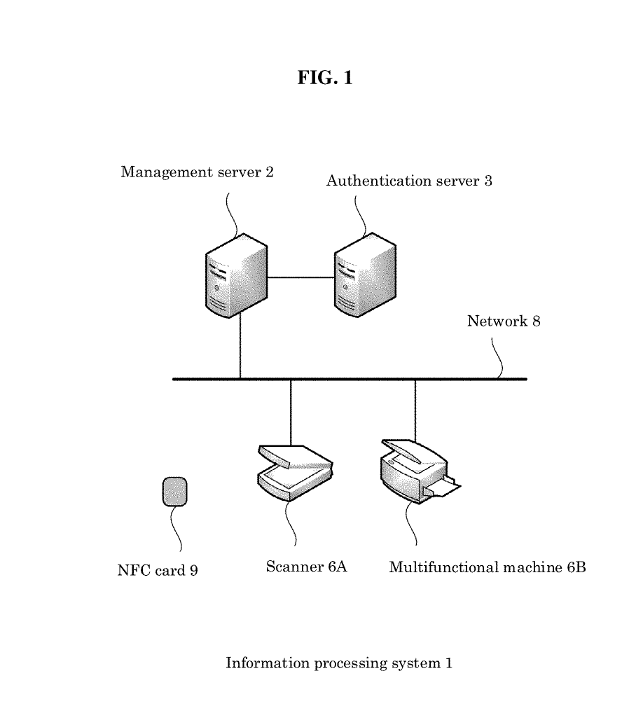

FIG. 1 is a drawing illustrating an overall configuration of the information processing system 1. As illustrated in FIG. 1, the information processing system 1 includes a management server 2, an authentication server 3, a scanner 6A, a multifunctional machine 6B, and an NFC card 9. The scanner 6A and the multifunctional machine 6B are connected, via a network 8, to the management server 2. Further, the authentication server 3 is connected to the management server 2.

The management server 2 is a computer terminal configured to provide information used for reading data from a recording medium. Here, the information used for reading data from the recording medium includes information indicating a location of a recording region in the recording medium (a block number, an address or the like), and command information for communicating with the recording medium, for example. The management server in the present example distributes a necessity of the authentication, an authentication method, and parameter information used for reading the NFC, to the scanner 6A or the multifunctional machine 6B. Further, in response to a request from the scanner 6A or the multifunctional machine 6B, the management server 2 in the present example requests a user authentication to the authentication server 3 and returns an authentication result to the scanner 6A or the multifunctional machine 6B. It is noted that the management server 2 is an example of an information provision device according to the present invention.

The authentication server 3 is a computer terminal configured to perform a user authentication. The authentication server 3 in the present example performs a user authentication, in response to a request from the management server 2, and returns an authentication result to the management server 2.

The scanner 6A is a scanner device configured to read data from a recording medium and to operate according to the read data.

The multifunctional machine 6B is an image formation multifunctional device configured to read data from a recording medium, and according to the read data, to implement a printing process, a facsimile transmission and reception, and a scanning process.

The scanner 6A and the multifunctional machine 6B in the present example use the parameter information distributed from the management server 2 to read the data from the NFC card 9, and transmit the read data to the management server 2 to request the user authentication.

It is noted that the scanner 6A and the multifunctional machine 6B are a specific example of a reading device according to the present invention; but are not limited thereto. For example, any device configured to read data from a recording medium in a non-contact manner and to operate on the basis of the read data, such as an access management device, may also be acceptable.

The NFC card 9 is a recording medium embedded with an IC chip capable of reading and writing data in a non-contact manner. The NFC card 9 in the present example is a card medium embedded with an IC chip configured to perform communication based on the near field communication standards of 13.56 MHz band. It is noted that the NFC card 9 is an example of a recording medium according to the present invention, but is not limited thereto. For example, a mobile telephone in which an IC chip is installed may also be acceptable.

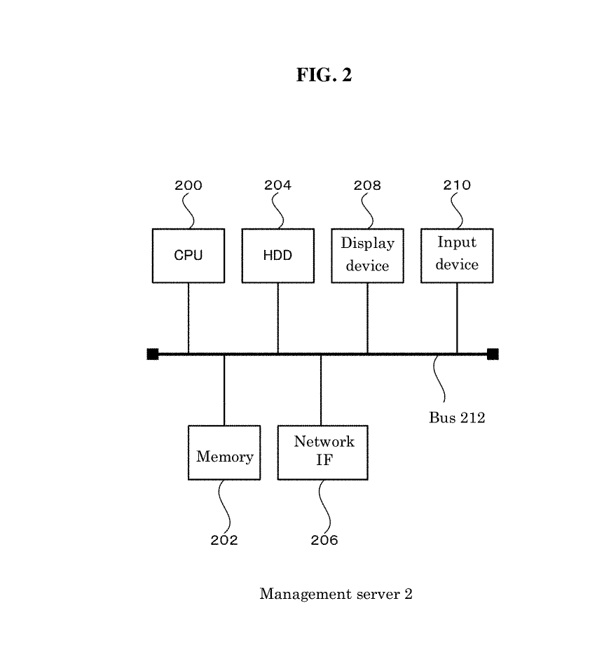

FIG. 2 is a drawing illustrating a hardware configuration of the management server 2.

As illustrated in FIG. 2, the management server 2 includes a CPU 200, a memory 202, an HDD 204, a network interface 206 (network IF 206), a display device 208, and an input device 210. These components are connected, via a bus 212, to one another.

The CPU 200 is a central processing unit, for example.

The memory 202 is a volatile memory, for example, and functions as a main storage device.

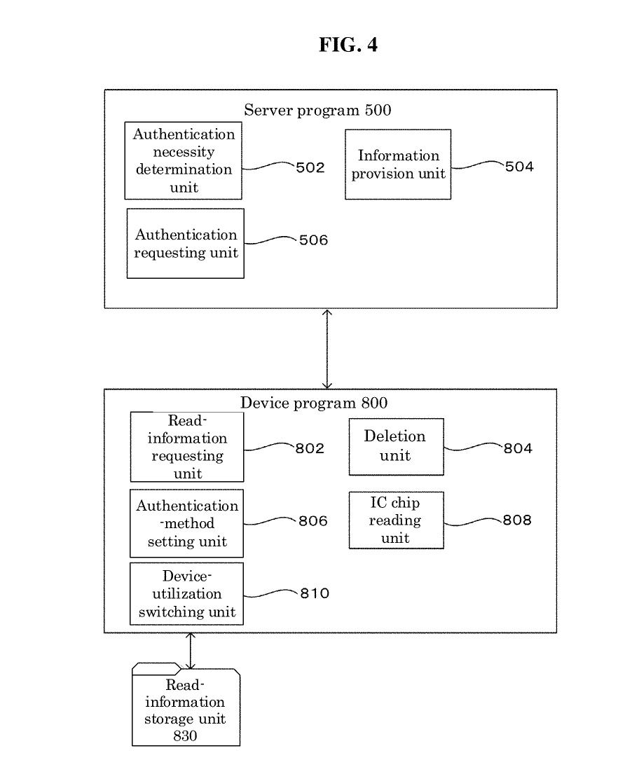

The HDD 204 is a hard disk drive device, for example, and serves as a non-volatile recording device to store a computer program (a server program 500 of FIG. 4, for example) and another data file.

The network IF 206 is an interface for communication by cable or radio.

The display device 208 is a liquid crystal display, for example.

The input device 210 is a keyboard or a mouse, for example.

It is noted that the authentication server 3 has a similar configuration.

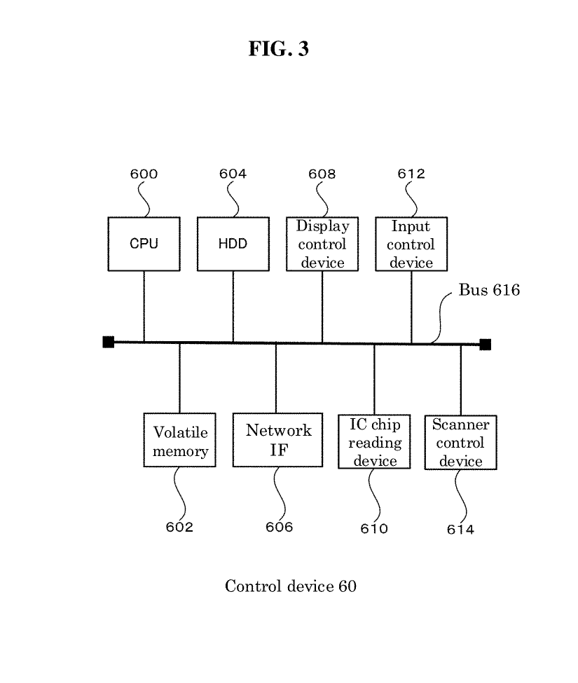

FIG. 3 is a diagram illustrating a hardware configuration of a control device 60 incorporated in the scanner 6A.

As illustrated in FIG. 3, the control device 60 includes a CPU 600, a volatile memory 602, an HDD 604, a network interface 606 (network IF 606), a display device 608, an IC chip reading device 610, an input control device 612, and a scanner control device 614. These components are connected, via a bus 616, to one another.

The CPU 600 is a central processing unit, for example. The volatile memory 602 is a recording device configured by DRAM, for example, and functions as a main storage device and holds a parameter used in the IC chip reading device 610.

The HDD 604 is a hard disk drive device, for example, and serves as a non-volatile recording device to store a computer program (a device program 800 in FIG. 4, for example) and another data file.

The network IF 606 is an interface for communication by cable or radio.

The display device 608 is a liquid crystal display, for example.

The IC chip reading device 610 is a reader device configured to read the data from the NFC card 9. The input control device 612 is a control device configured to control an operation panel, for example.

The scanner control device 614 is a control device configured to control a scanning operation of the scanner 6A.

It is noted that the multifunctional machine 6B has a similar configuration.

FIG. 4 is a drawing illustrating a functional configuration of the management server 2 and the scanner 6A.

As illustrated in FIG. 4, in the management server 2, the server program 500 is installed. Further, in the scanner 6A, the device program 800 is installed, and a read-information storage unit 830 is configured in the volatile memory 602.

The server program 500 and the device program 800 are stored in a recording medium such as a CD-ROM, for example, and are installed respectively in the management server 2 and the scanner 6A via the recording medium.

It is noted that the server program 500 and the device program 800 may be partially or completely realized by a hardware such as an ASIC. Further, the server program 500 and the device program 800 may be partially or completely realized by borrowing a part of a function of OS (Operation System).

As illustrated in FIG. 4, the server program 500 includes an authentication necessity determination unit 502, an information provision unit 504, and an authentication requesting unit 506.

In the server program 500, the authentication necessity determination unit 502 determines whether the user authentication is necessary when a user logs onto the scanner 6A.

The information provision unit 504 distributes information used for reading data from the recording medium, to the scanner 6A. For example, the information provision unit 504 provides the information only to a device (the scanner 6A and the multifunctional machine 6B) connected to the common network 8. Here, the common network 8 is a network capable of communication without passing through a router, for example, and in this example, a common Local Area Network (LAN) is an example thereof. Further, the information provision unit 504 is triggered when power is fed to the scanner 6A, when a user logs out, or when the scanner 6A returns to an operation state from a sleep state, to distribute the information used for reading the data from the NFC card 9, to the scanner 6A.

The information provision unit 504 in the present example distributes, to the scanner 6A, the parameter information for reading the data from the NFC card 9, a determination result by the authentication necessity determination unit 502 (necessity of the user authentication), and the authentication method of the user authentication.

The authentication requesting unit 506 requests a user authentication to the authentication server 3, in response to a request from the scanner 6A, and returns the result of the user authentication by the authentication server 3, to the scanner 6A. It is noted that in the present example, a mode in which the management server 2 requests a user authentication to the authentication server 3 has been described as a specific example, but this is not limiting. For example, the management server 2 may perform a user authentication.

Further, as illustrated in FIG. 4, the device program 800 includes a read-information requesting unit 802, a deletion unit 804, an authentication-method setting unit 806, an IC chip reading unit 808, and a device-utilization switching unit 810.

In the device program 800, the read-information requesting unit 802 requests information used for reading data from the NFC card 9, to the management server 2. The read-information requesting unit 802 in the present example requests information used for reading data from the NFC card 9 when power is fed to the scanner 6A, when a user logs out, or when the scanner 6A returns to an operation state from a sleep state.

The deletion unit 804 deletes information stored in the read-information storage unit 830 when a predetermined condition is satisfied. Specifically, under a condition that it is completed to read data by the IC chip reading unit 808, the deletion unit 804 deletes information used for reading data from the NFC card 9 stored in the read-information storage unit 830. More specifically, under a condition that it is completed to read data by the IC chip reading unit 808 and the user authentication by the read data is successful, the deletion unit 804 deletes information used for reading data from the NFC card 9 stored in the read-information storage unit 830.

The deletion unit 804 in the present example deletes information used for reading data from the NFC card 9 stored in the read-information storage unit 830 when receiving from the management server 2 an indication that a user authentication is successful, when the power of the scanner 6A is turned OFF, or when the scanner 6A is shifted to a sleep state. In other words, when the device is in a normally activated state, and if reading of data by the IC chip reading unit 808 is not completed, or if a user authentication is not successful, information used for reading data from the NFC card 9 is held in the read-information storage unit 830.

The authentication-method setting unit 806 sets the authentication method of the user authentication, based on the information distributed from the information provision unit 504. Upon reception of the necessity of the authentication, the authentication method, and the parameter information used for reading the NFC, from the information provision unit 504, the authentication-method setting unit 806 in the present example sets the parameter information to the IC chip reading unit 808 according to the received information.

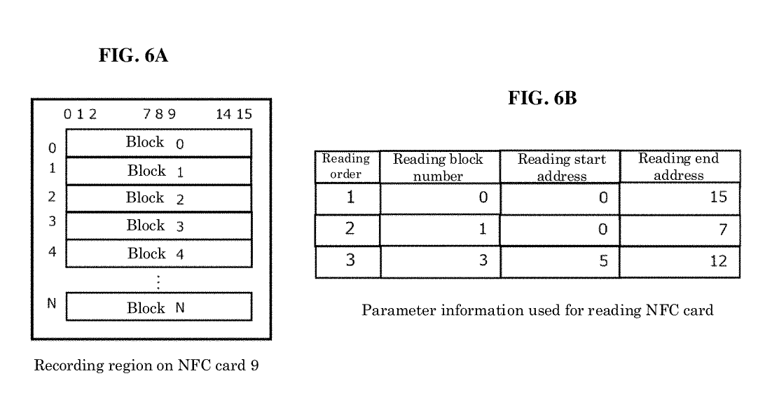

The IC chip reading unit 808 uses the information stored in the read-information storage unit 830 to read the data from the recording medium. The IC chip reading unit 808 in the present example uses the parameter information stored in the read-information storage unit 830 to read the data from the NFC card 9. A recording region on the NFC card 9 is divided into a plurality of blocks as illustrated in FIG. 6A, and based on the parameter information illustrated in FIG. 6B, the IC chip reading unit 808 reads data from a read-start address to a read-end address of a block defined by the parameter information, according to a reading order defined by the parameter information.

The device-utilization switching unit 810 switches an operation of the scanner 6A, according to the result of the user authentication. For example, the device-utilization switching unit 810 allows a user successful in the user authentication to operate the scanner 6A in an operation manner defined for each user.

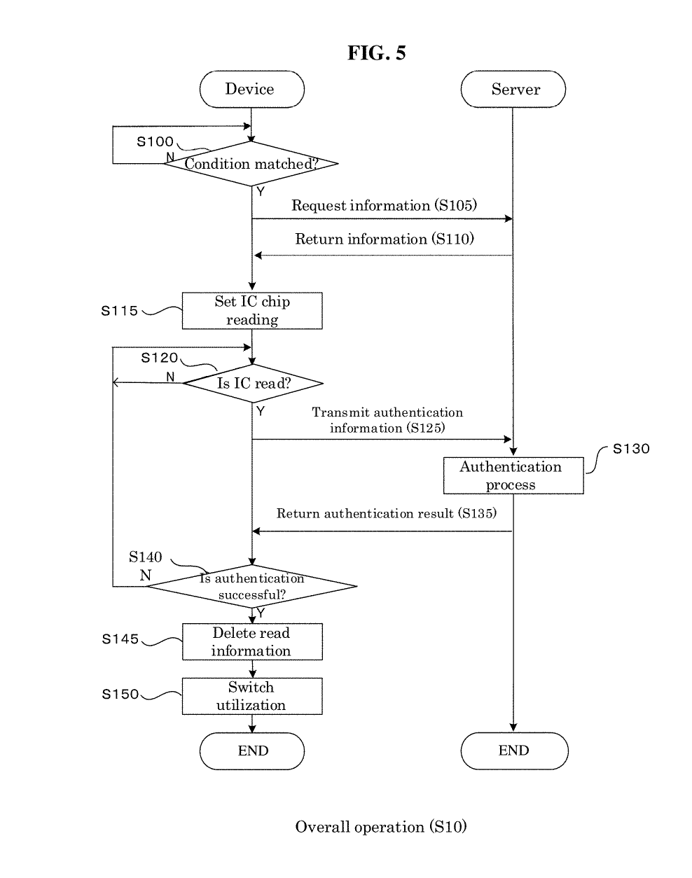

FIG. 5 is a sequence chart explaining an overall operation (S10) of the information processing system 1.

As illustrated in FIG. 5, in step 100 (S100), the scanner 6A (the read-information requesting unit 802 in FIG. 4) shifts to a process in S105, when power is fed to the scanner 6A, when a user logs out from the scanner 6A, or when the scanner 6A returns to an operation state from a sleep state (S100: Yes), and otherwise (S100: No), waits in a standby state.

In step 105 (S105), the read-information requesting unit 802 requests information used for reading data from the NFC card 9, to the management server 2. In step 110 (S110), the information provision unit 504 of the management server 2 returns the necessity of the authentication, the authentication method, and the parameter information used for reading the NFC, to the read-information requesting unit 802 of the scanner 6A.

In step 115 (S115), the authentication-method setting unit 806 of the scanner 6A sets the authentication method of the scanner 6A, according to the necessity of the authentication, the authentication method, and the parameter information used for reading the NFC which are received from the read-information requesting unit 802. At this time, the received parameter information is stored in the read-information storage unit 830.

In step 120 (S120), the scanner 6A waits until a user places the NFC card 9 over the IC chip reading device 610 (S120: No), and when the NFC card 9 is placed, the IC chip reading unit 808 controls the IC chip reading device 610 according to the parameter information stored in the read-information storage unit 830 to read the data from the NFC card 9.

In step 125 (S125), the device-utilization switching unit 810 transmits the data read by the IC chip reading unit 808 to the management server 2 to request the user authentication.

In step 130 (S130), the authentication requesting unit 506 of the management server 2 instructs the authentication server 3 to perform the user authentication based on the data received from the device-utilization switching unit 810.

In step 135 (S135), the authentication requesting unit 506 returns the authentication result by the authentication server 3, to the device-utilization switching unit 810 of the scanner 6A.

In step 140 (S140), the scanner 6A (device-utilization switching unit 810) shifts to a process of S145 when receiving an indication that the authentication is successful as the authentication result, and returns to the process of S120 when receiving an indication that the authentication is unsuccessful as the authentication result.

In step 145 (S145), the deletion unit 804 deletes the parameter information stored in the read-information storage unit 830. In step 150 (S150), the device-utilization switching unit 810 instructs the scanner control device 614 to switch to the operation method defined to a user who was successful in the authentication.

As described above, in the information processing system according to the present embodiment, the parameter information needed to read the NFC card 9 is distributed at a necessary timing, and when the authentication based on the data read from the NFC card 9 is successful, the parameter information is deleted. As a result, it is possible to prevent forgery and a fraudulent reading of the NFC card 9.

Further, the parameter information distributed to the scanner 6A is stored only in the volatile memory, and thus, the parameter information is automatically deleted when the power of the scanner 6A is turned OFF. As a result, even if the scanner 6A is stolen, the parameter information cannot be extracted from the device. In addition, the parameter information is distributed only when the scanner 6A is connected to the common network 8 with the management server 2, and thus, the parameter information is prevented from being distributed to the scanner 6A stolen to outside a management area.

Further, in the information processing system 1 of the present embodiment, the necessity of the authentication, the authentication method, and the parameter information are centrally managed by the management server 2, and thus, a setting change or the like for the user authentication is easy.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a reading device configured to read data from a recording medium; and
an information provision device configured to provide information used for reading data from the recording medium, wherein the reading device comprises:
a memory; and
a processor coupled to the memory configured to:
store, in the memory, information provided from the information provision device;
read data from the recording medium by using the information stored in the memory; and
delete the information stored in the memory when a predetermined condition is satisfied.

2. The information processing system according to claim 1, wherein the memory is a volatile memory.

3. The information processing system according to claim 1, wherein the processor is further configured to delete the information stored in the memory, under a condition that it is completed to read data from the recording medium.

4. The information processing system according to claim 3, wherein the processor is further configured to delete the information stored in the memory, under a condition that a user authentication for the read data is successful.

5. The information processing system according to claim 1, wherein the information provision device is further configured to provide information used for reading data from the recording medium to the reading device when the reading device is powered on, when a user logs out, or when the reading device returns to an operation state from a sleep state.

6. The information processing system according to claim 1, wherein the processor is further configured to delete, from the memory, at least information indicating a recording region for the data in the recording medium.

7. The information processing system according to claim 1, wherein the information provision device is further configured to provide the information used for reading data from the recording medium, under a condition that the reading device is connected to a common network with the information provision device.

8. A reading device, comprising:
a memory; and
a processor coupled to the memory configured to:
store, in the memory, information used for reading data from a recording medium, wherein the information is provided from outside;
read data from the recording medium by using the information stored in the memory; and
delete the information stored in the memory when a predetermined condition is satisfied.

9. An information processing method comprising the steps of:
obtaining information used for reading data from a recording medium, from outside;
storing the obtained information into a predetermined recording region;
reading data from the recording medium by using the information stored in the recording region; and
deleting the information stored in the recording region when a predetermined condition is satisfied.
